(19) United States
(12) Patent Application Publication
(10) Pub. No.: US 2003/0034405 A1
(43) Pub. Date: Feb. 20, 2003

(54) Shower device

(76) Inventor: Elvis Hsieh, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/928,689

(22) Filed: Aug. 14, 2001

(51) Int. Cl. B05B 1/14

(52) U.S. Cl. 239/553; 239/537; 239/538

(57) ABSTRACT

A shower device having a hollow body is disclosed. The body has a water inlet end and a water outlet end configured with respect to the water inlet end. The hollow body is installed with filtering materials. The water inlet end is installed with a ball joint which can rotate through 360 degrees for being connected with a water supply tube. The ball joint has channel; water flows through the channel to the body. The water outlet end is installed with a cover. The cover is installed with a plurality of water outlet holes.

### FIELD OF THE INVENTION

The present invention relates to a shower device, and particularly to a shower device with filtering materials therein and having a ball joint capable of rotating through 360 degrees at the water inlet end, and the shower device has the function of filtering water and changing water outlet direction.

### BACKGROUND OF THE INVENTION

Referring to FIG. 8, a prior art shower device is illustrated. In this prior art, a distal end of a water supply tube 81 has a ball joint 81 which is connected to a shower spraying head 83. Therefore, as the user uses the shower spraying head 83 for spraying. The ball joint 83 may be used to rotate the shower spraying head 83 for changing the water flow direction of the shower spraying head 83.

In above structure, the ball joint 82 is used to rotate the direction of the shower spraying head 83. The bathing using hot water, the chlorine in the water will evaporate so as to be filled in the space of the bathroom. The odor of the chlorine is not preferred. Furthermore, the dust in the water tube may be sprayed to the user, even they are adhered to the body of the user. Therefore, the prior art design is necessary to be improved.

### SUMMARY OF THE INVENTION

Accordingly, the primary object of the present invention is to provide a shower device having a hollow body. The body has a water inlet end and a water outlet end with respect to the water inlet end. The hollow body is installed with filtering materials. The water inlet end is installed with a ball joint which can rotate through 360 degrees for being connected with a water supply tube. The ball joint has channel; water flows through the channel to the body. The water outlet end is installed with a cover. The cover is installed with a plurality of water outlet holes.

Another object of the present invention is to provide a separable zipper head, wherein the casing has an end with respect to the ball joint is installed with an O ring; the cover resists against the casing; the casing tightly resists the ball joint to be positioned therein.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a cross sectional view along II-II of FIG. 1.

FIG. 3 is a schematic view showing the using of the present invention.

FIG. 4 is a perspective view of the second embodiment in embodiment.

FIG. 5 is a schematic view of the V-V of FIG. 4.

FIG. 6 is a perspective view of the third embodiment of the present invention.

FIG. 7 is a schematic view along III-III of FIG. 6.

FIG. 8 shows the prior art shower device.

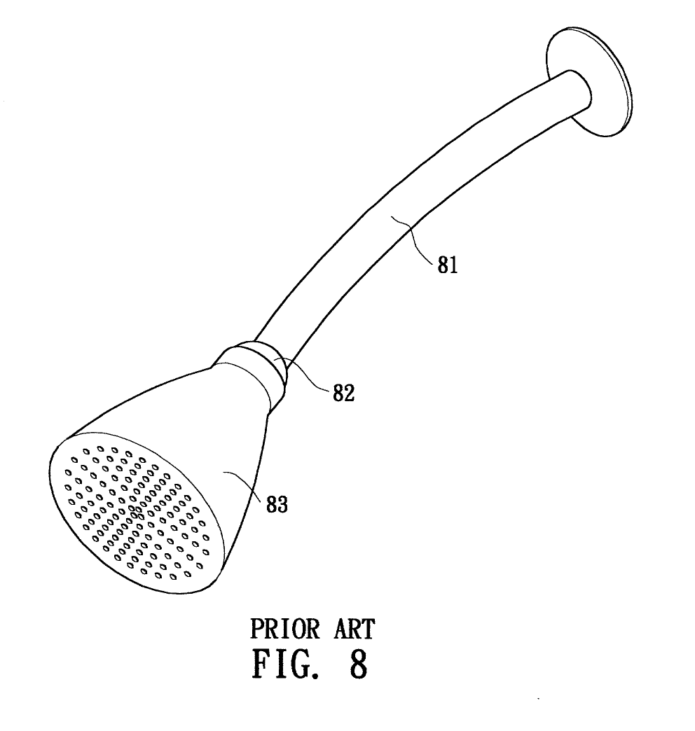

### DETAILED DESCRIPTION OF THE PREFERRED EMBODIMENTS

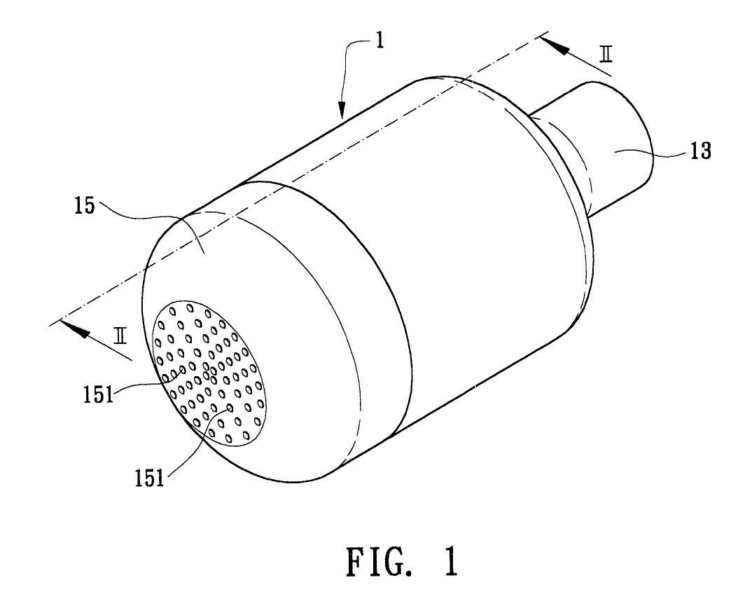

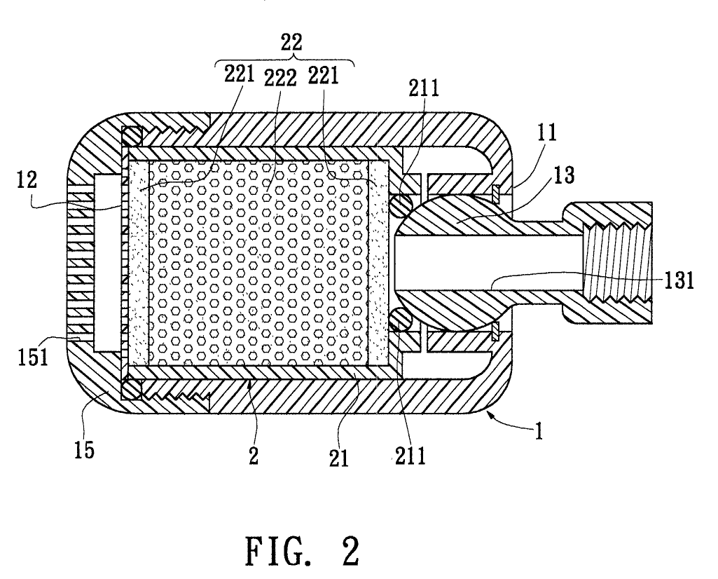

Referring to FIGS. 1 to 7, the present invention relates to a shower device. The shower device of the present invention has a hollow body 1. The body 1 has a water inlet end 11 and a water outlet end 12 with respect to the water inlet end 11. The hollow body 1 is installed with a filter set 2. The water inlet end 11 is installed with a ball joint 13 which can rotate through 360 degrees for being connected with a water supply tube 14. The ball joint 13 has a channel 131. Water may flow through the channel to the body 1. The water outlet end 12 is installed with a cover 15. The cover 15 is installed with a plurality of water outlet hole 151. The filter set 2 has a casing 21. The casing 21 is installed in the hollow body 1. The casing 21 is installed with filtering material 22. In this embodiment, the filtering material includes two sponge filtering material 221 and two particle filtering material 222. The casing 21 has an end with respect to the ball joint 13 being installed with an O ring 211. The cover 15 resists against the casing 21. The casing 21 tightly resists against the ball joint 13 to be positioned therein.

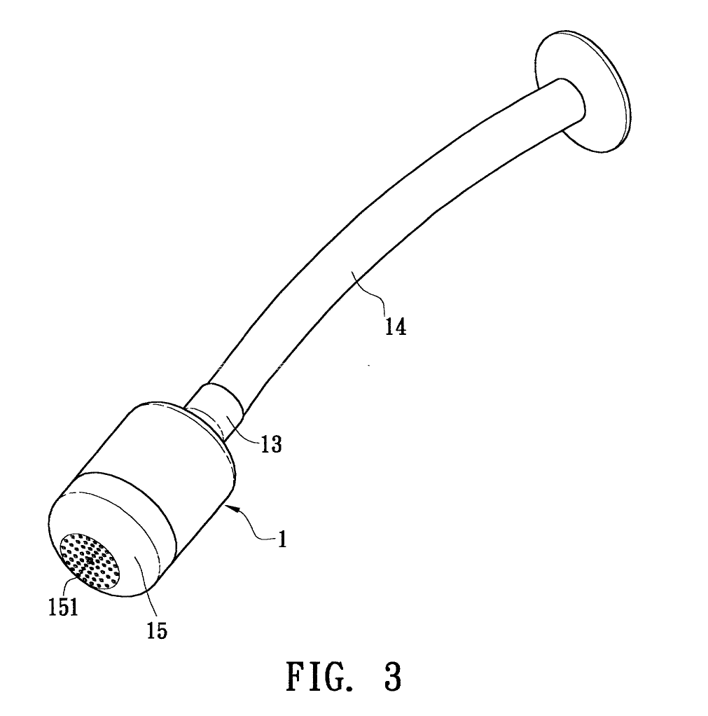

Referring to FIG. 3, in installing, the ball joint 13 is connected to the water supplying tube 13, the body 1 may be rotated as desired to a selected position. Thereby, water flows through the filter set 2 in the body 1. Then water is sprayed from the water outlet hole 151 on the cover 15 at the water inlet end 11. Therefore, since the body 1 is installed with a filter set 2 so that the impurities in water is filtered by the filter set 2. Therefore, the quality of the water is improved. The installation of the ball joint 13 causes the body 1 to be adjusted to rotate through 360 degrees so as to change the water outlet direction from the water outlet hole 151 on the cover 15.

In summary, in the present invention, a filter set 2 is installed in the hollow body 1. The water inlet end 11 of the body 1 is installed with the ball joint 13 connected to the water supply tube 14 and capable of rotating through 360 degrees. The water outlet end 12 of the body 1 has a cover 15. The cover 15 has a water outlet hole 151 which has the effect of filtering water and changing water outlet direction.

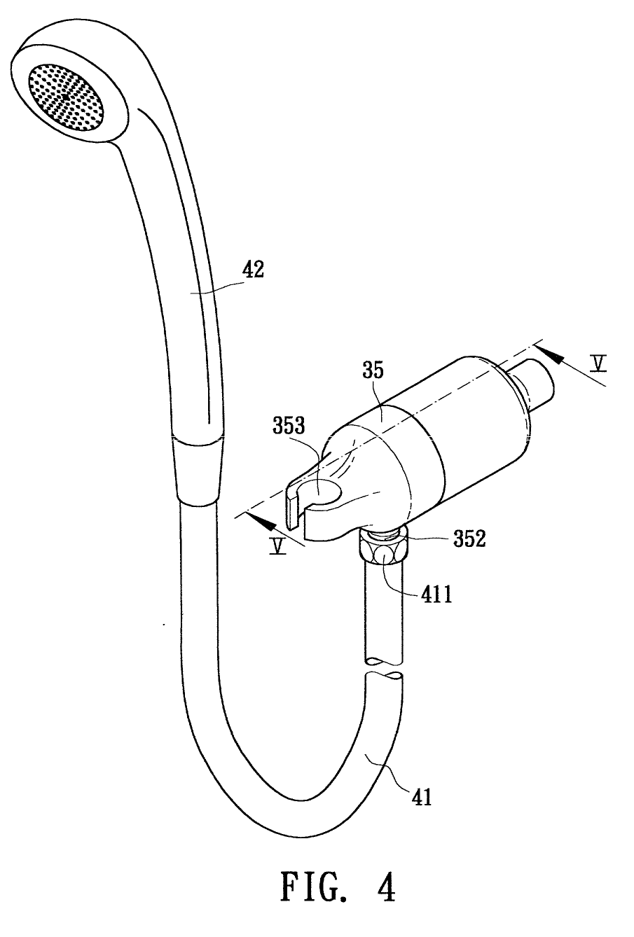

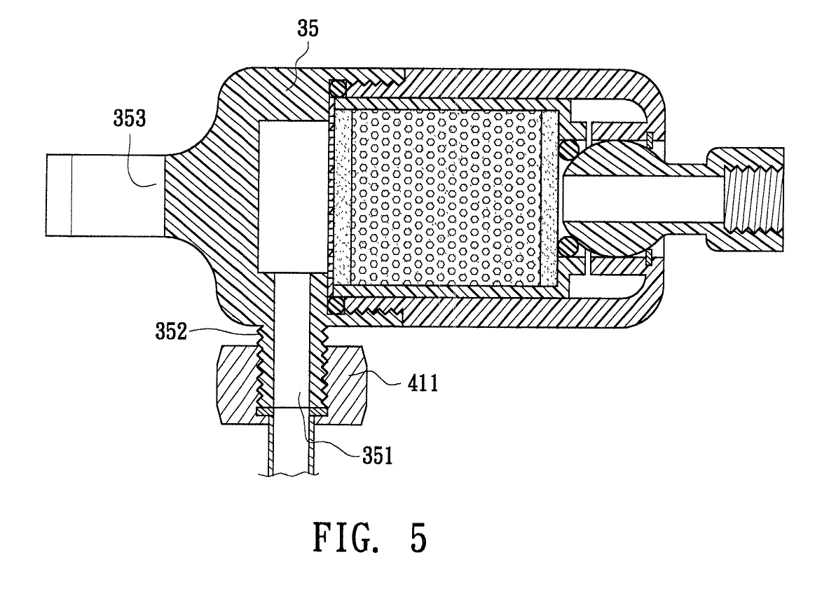

With reference to FIGS. 4 and 5, the second embodiment of the present invention is illustrated. The periphery of the cover 35 has a tube joint 352. The tube joint 352 is connected to the joint 411 of a soft tube 41. The water outlet hole 351 penetrates through the tube joint 352. The end of the soft tube 41 with respect to the joint 411 is installed with a shower spraying head 42. A front end of the cover 15 has a receptacle 353 for being inserted by the shower spraying head 42. Thereby, other than achieving the same effect of the first embodiment, the shower spraying head 42 with a soft tube 41 can be used conveniently.

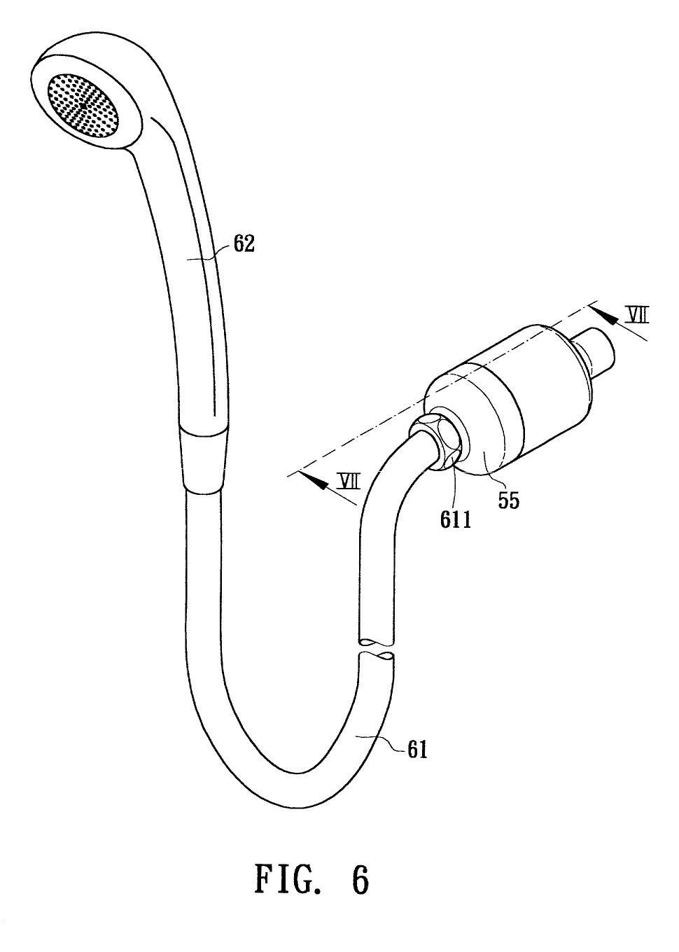

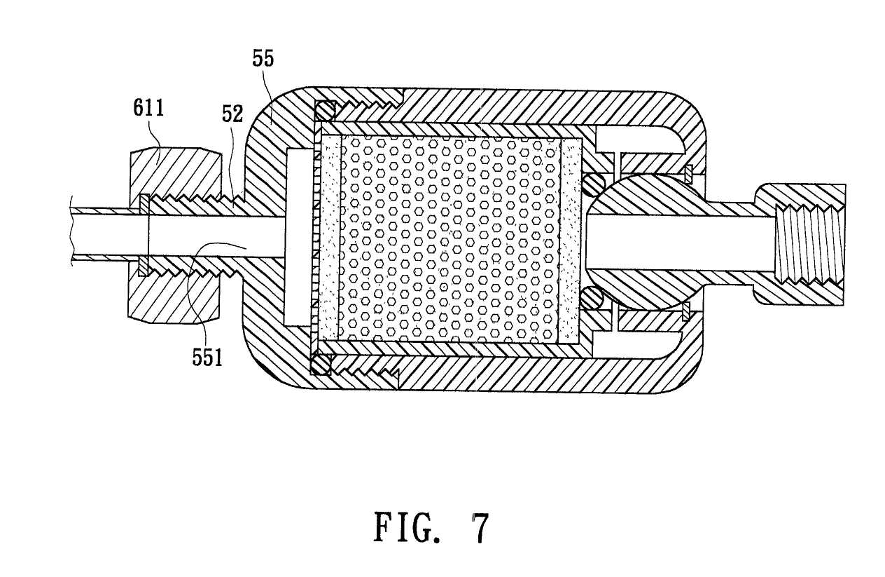

Referring to FIGS. 6 and 7, a third embodiment of the present invention is illustrated. A front end of the cover 55 is installed with a tube joint 552. The water outlet hole 551 penetrates through the tube joint 552. The tube joint 552 is used to be connected to a joint 611 of the soft tube 61. One end of the soft tube 61 with respect to the joint 611 is installed with a shower spraying head 62. Thereby, the effect of the first embodiment is achieved.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A shower device having a hollow body; the body having a water inlet end and a water outlet end with respect to the water inlet end; the hollow body being installed with filtering materials; the water inlet end being installed with a ball joint which can rotate through 360 degrees for being connected with a water supply tube; the ball joint having channel; water flows through the channel to the body; the water outlet end being installed with a cover; the cover being installed with a plurality of water outlet holes.

2. The separable zipper head as claimed in claim 1, wherein the cover is extended with a tube joint; and the water outlet hole penetrates through the tube joint.

3. The separable zipper head as claimed in claim 1, wherein the cover is extended with a tube joint, the water outlet hole penetrates through the tube joint; and the cover has a shower spraying receptacle.

4. The separable zipper head as claimed in claim 1, wherein the filtering material is installed with a casing; and the casing is installed in the hollow body.

5. The separable zipper head as claimed in claim 4, wherein the casing has an end with respect to the ball joint being installed with an 0 ring; the cover resists against the casing; the casing tightly resists the ball joint to be positioned therein.
